(19) United States
(12) Patent Application Publication
(10) Pub. No.: US 2013/0174583 A1
(43) Pub. Date: Jul. 11, 2013

(54) METHODS FOR STORING CRYOGENIC FLUIDS IN STORAGE VESSELS

(71) Applicant: Ron C. Lee, Bloomsbury, NJ (US)

(72) Inventor: Ron C. Lee, Bloomsbury, NJ (US)

(21) Appl. No.: 13/344,824

(22) Filed: Jan. 6, 2012

(51) Int. Cl. F17C 5/04; F17C 7/04

(52) U.S. Cl. 62/47.1; 62/48.1

(57) ABSTRACT

A method for maintaining a subcooled bottom state or the natural convection current of a liquefied natural gas in a storage vessel by the use of an external heat exchanger. The liquefied natural gas is removed from the storage vessel and cooled in the external heat exchanger by a cryogenic fluid such as liquid nitrogen. The cooled liquefied natural gas is reintroduced back into the storage vessel thereby maintaining a subcooled bottom layer or natural convection current in the storage vessel.

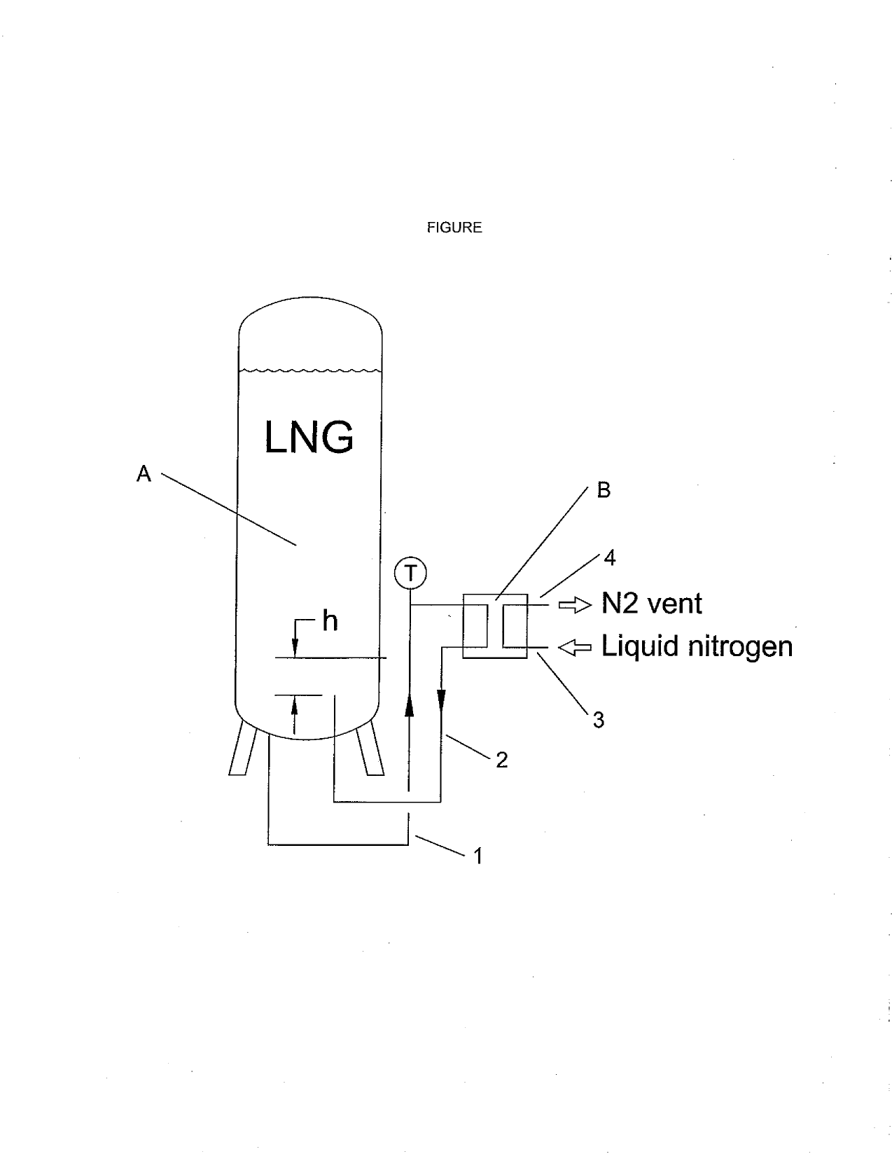

### BACKGROUND OF THE INVENTION

The present invention provides for a method for maintaining a subcooled state of a cryogenic fluid such as liquefied natural gas (LNG) in a storage vessel. A portion of the cryogenic fluid is removed from the storage vessel, cooled and then reintroduced back into the storage vessel.

Liquefied natural gas is composed primarily of methane, which comprises about 85 to 98% of the LNG on a molar basis. Lesser components that may be present include ethane, propane, carbon dioxide, oxygen and nitrogen. For the purposes of illustration, the properties of pure methane will be used to characterize LNG.

Liquefied natural gas bulk storage vessels, especially those used in refuelling stations, are subject to both heat load and returned gas and/or two-phase associated with the fuelling operation. This causes a significant heat load to the storage vessel, which typically results in gas venting. This venting is both a loss of valuable product, as well as a significant environmental issue because natural gas is a powerful greenhouse gas. Maintaining the contents of the bulk storage vessel in a subcooled state (temperature below the boiling point corresponding to the storage tank pressure) will prevent most or all of this venting. However, the amount of subcooling available depends on the temperature of the supplied liquid to the bulk storage vessel, and will be lost through warming after a period of time. Hence venting from LNG storage vessels is routine and a significant impediment to successful implementation of natural gas as a vehicle fuel.

LNG vehicle fuel tanks typically have an optimum storage pressure of about 6-8 barg in order to deliver the fuel to the engine without the assistance of a pump or compressor. If the liquid supplied during refueling is at a temperature above the saturation temperature corresponding to the optimum storage pressure then the fuel tank must typically vent during refueling. It is therefore desirable for the temperature of the LNG supplied from the bulk storage tank be at or somewhat below the saturation temperature corresponding to the optimum onboard storage pressure. For example, at 6 barg the saturation temperature is about −131° C. This allows the refueling to occur with little or no venting, and the storage tank is filled at close to the optimum onboard storage pressure.

Further, in the case of an onboard fuel tank that is initially at an elevated pressure relative to the optimum pressure, it is generally advantageous to first introduce subcooled LNG in order to collapse the existing gas in the fuel tank.

### SUMMARY OF THE INVENTION

The invention provides for a method for maintaining a subcooled state within a cryogenic fluid such as liquefied natural gas in a storage vessel comprising removing a portion of the cryogenic fluid, cooling the removed portion of cryogenic fluid and reintroducing the removed portion of cryogenic fluid back into the liquid region of the storage vessel.

Cryogenic fluids suitable for the present invention include liquefied natural gas, liquid nitrogen, liquid oxygen, liquid air, and liquid argon and mixtures of these fluids. Other fluids and fluid mixtures, such as ethylene, while not typically classified as cryogenic are also suitable for the present invention. When these fluids or mixtures of fluids are stored in a vessel, it is natural for liquid and vapor fractions of the fluid to form and separate. Where mixtures of these fluids are contained as the sole contents of a storage vessel, then the molar ratio of the components will be different in the liquid and vapor phases according to equilibrium thermodynamics.

The removed portion of cryogenic fluid is preferably removed from near the bottom of the storage vessel, and is preferably fed back into the storage vessel at a position higher than where the cryogenic fluid was removed. This will help establish a uniform bottom subcooled layer in the storage vessel. Typically a cryogenic fluid such as liquid nitrogen is used to cool the removed portion of cryogenic fluid; however other cryogenic fluids such as liquid air, oxygen, and argon and mixtures of these fluids can be employed or mechanical refrigeration means or a heat transfer fluid cooled by other means may be employed. The cooling provided by the cryogenic fluid such as liquid nitrogen is preferably performed in an external heat exchanger that is at an elevation higher than the position in the tank where the removed liquefied natural gas is returned. The cooling of the cryogenic fluid will increase its density and it will cause a natural circulation (thermosiphon) loop of removed liquefied natural gas and its return into the storage vessel, without the aid of a pump. While this is a preferred means, other methods of circulation such as those aided by a pump may be employed. The removal of the cryogenic fluid can be performed continuously as needed or it can be performed periodically in that cryogenic fluid is removed from the storage vessel on an intermittent schedule.

The cryogenic fluid such as liquid nitrogen is in a heat exchanger that is positioned external to the cryogenic fluid storage vessel. The amount of cryogenic fluid supplied to the heat exchanger is adjusted to maintain the desired degree of subcooling of the cryogenic fluid present in the storage vessel. This cooling can also be provided by other cryogenic fluids, a heat transfer fluid cooled by other means, or mechanical refrigeration. The cryogenic fluid is vented from the heat exchanger after performing its heat exchange duties.

In another embodiment, there is disclosed a method for maintaining the natural convection current of a cryogenic fluid in a storage vessel comprising removing a portion of the cryogenic fluid, cooling the removed portion of cryogenic fluid and reintroducing the removed portion of cryogenic fluid back into the storage vessel.

The storage vessel can be selected from any serviceable design, size or orientation. The piping connections into or out of the storage vessel may be suitably modified as well. The return flow of subcooled cryogenic fluid into the storage vessel may be ether above or below the location where the cryogenic fluid is removed inside the bulk storage vessel. The piping used for the preferred mode of thermosiphon action for subcooling may be in addition to or the same as the piping used for thermosiphon cooling of an external cryogenic pump.

Additional piping into and/or out of the vessel is also possible, including for the return flow of gas and/or liquid into the bottom or top regions of the vessel.

Additional control elements, as necessary, such as control valves, or temperature or pressure sensing devices may also be used to control the degree and rate of external subcooling.

The cryogenic fluid such as nitrogen gas that is vented from the external heat exchanger may be used in other unit operations where the cryogenic fluid storage vessel is located such as cooling operations, inerting, or as a pressurizing gas to operate valves.

The placement of the external heat exchanger can be modified to optimize the circulation due to thermosiphon behavior and the return and supply lines can be supplemented with a cryogenic pump.

Additional methods for vessel pressure control and condensation of vapor are possible and may be used in conjunction with the invention. For example, during vessel filling a combination of top and bottom filling with subcooled liquid may be employed for maintaining storage vessel pressure. Additionally, an external cryogenic pump maybe arranged to periodically circulate a portion of the bottom subcooled liquid to the top of the cryogenic vessel in order to directly condense vapor.

While the detailed description of the invention below discusses liquefied natural gas as the cryogenic fluid that is present in the storage vessel, the methods of the invention would be applicable to other cryogenic fluids such as liquid nitrogen, liquid oxygen, liquid air, liquid argon, and ethylene and mixtures of these fluids

### BRIEF DESCRIPTION OF THE DRAWINGS

The FIGURE is a schematic of a cryogenic fluid storage vessel and secondary refrigeration source according to the invention.

### DETAILED DESCRIPTION OF THE INVENTION

Turning to the FIGURE, a liquefied natural gas bulk storage vessel containing LNG at an elevated pressure is shown. Liquefied natural gas is present in bulk storage vessel A which is in fluid communication with heat exchanger B. Liquid natural gas will be withdrawn from the bulk storage vessel A through line 1 where it will be directed to the heat exchanger B. The liquefied natural gas in line 1 will be cooled further by heat exchange with liquid nitrogen. The further cooled liquefied natural gas is returned to the bulk storage vessel through line 2. The liquid nitrogen will be fed into heat exchanger B through line 3 which passes through heat exchanger B. The liquid nitrogen will be heated by the heat exchange process and be vented from the heat exchanger B through line 4 as nitrogen gas.

A liquefied natural gas (LNG) bulk storage vessel contains LNG at an elevated pressure. The LNG in the bulk container is generally comprised of a top saturated layer (liquid at the boiling point temperature corresponding to the storage pressure) and an underlying subcooled layer (liquid at a temperature colder than the boiling point corresponding to the storage pressure). The underlying subcooled layer may further have spatial temperature variation. The equilibrium condition of this two layer arrangement is for natural convection currents within the tank, caused by heat load from the vessel wall as well as gas which may be introduced into the bottom of the vessel, to cause the top saturated layer to become extremely thin. As heat or bottom gas is continued to be added to the vessel, only this thin top saturated layer will vaporize, while the bottom subcooled layer will warm without vaporization. During this period of time there will not typically be any significant venting because as liquid is withdrawn, the amount of vaporization of the thin saturated layer will be compensated by the volume of liquid withdrawn. Ultimately, however, the heat addition will destroy the subcooling throughout the bottom layer and the entire vessel will become saturated. At that point, any further heat or gas addition will cause only LNG vaporization without warming. In order to maintain the desired pressure within the vessel, it then becomes necessary to vent natural gas.

The method the present invention is to inhibit the destruction of the bottom subcooled layer in a liquefied natural gas storage vessel. It is a further object of the present invention to maintain the bottom subcooled layer at a preferred temperature to facilitate optimum refueling of vehicle fuel tank. Accordingly the invention seeks to maintain a subcooled state within a bottom region of a cryogenic fluid in a storage vessel as well as maintain a subcooled state throughout the cryogenic fluid present in a storage vessel. By preventing the bottom subcooled layer's destruction over time, the bulk storage vessel will remain largely subcooled due to the natural convection currents previously described and the venting problem is significantly reduced or eliminated. This is accomplished by using a secondary refrigeration source (in this case, preferably a cryogenic fluid such as liquid nitrogen) to subcool a portion of the LNG in an external heat exchanger. While a pump could be used to circulate this subcooled LNG formed externally, a novel aspect of the invention and a preferred option is to rely on a thermosiphon effect for the circulation.

Turning to the FIGURE, two lines are shown entering the bottom of the bulk storage vessel, preferably separated both horizontally and vertically. The designation “h” refers to the elevation necessary for the external heat exchanger B to drive the thermosiphon effect as cooler liquefied natural gas is fed from a point higher in elevation than the point it is reintroduced into the bulk storage vessel. Liquefied natural gas is withdrawn from the storage vessel A through line 1 and directed to external heat exchanger B. Liquid nitrogen in line 3 is used to cool this side stream of LNG from Line 1 in the external heat exchanger B. As the external stream of LNG in the heat exchanger B is cooled sufficiently by the liquid nitrogen, which has a normal boiling point about 35° C. lower than that of LNG, it naturally becomes denser and tends to drop. This highly subcooled side stream of LNG flows downward through line 2 and back into the bottom of the bulk LNG storage vessel. As this highly subcooled LNG is returned to the bulk LNG storage vessel, it is naturally replaced in the external heat exchanger B by a return flow of warmer LNG from line 1. This natural circulation or thermosiphon effect is continued as long as liquid nitrogen is provided to the external heat exchanger B.

The amount of liquid nitrogen supplied is generally adjusted to maintain a preferred degree of bottom subcooling as indicated by the temperature T or other suitable temperature measurement of the LNG. A pump, not shown, is a possible addition to facilitate this circulation. However, one embodiment is the thermosiphon design described and illustrated as it provides a simpler, more reliable and lower cost solution. This thermosiphon design, in addition to piping arrangements, depends on a hydrostatic pressure head to drive the circulation. This distance, h, shown in the FIGURE illustrates how the hydrostatic head is produced through suitable placement of the external heat exchanger relative to the internal pipe terminations inside the storage vessel. A typical value for h is between 1 to 3 meters.

It is noted that the thermosiphon arrangement as shown in the FIGURE will only directly introduce externally subcooled LNG into the bottom region of the vessel. As earlier discussed, the natural convection currents that exist inside these vessels will ensure the majority of the vessel contents above this lower region will also be maintained in a subcooled state.

While this invention has been described with respect to particular embodiments thereof, it is apparent that numerous other forms and modifications of the invention will be obvious to those skilled in the art. The appended claims in this invention generally should be construed to cover all such obvious forms and modifications which are within the true spirit and scope of the invention.

Having thus described the invention, What I claim is:

1. A method for maintaining a subcooled state within a bottom layer of a cryogenic fluid in a storage vessel comprising removing a portion of the cryogenic fluid, cooling the removed portion of cryogenic fluid and reintroducing the removed portion of cryogenic fluid back into the liquid region of the storage vessel.

2. The method as claimed in claim 1 wherein the removed portion of cryogenic fluid is fed back into the storage vessel at a position higher than where the cryogenic fluid was removed from the storage vessel.

3. The method as claimed in claim 1 wherein a cryogenic fluid is used to cool the removed portion of cryogenic fluid.

4. The method as claimed in claim 3 wherein the cryogenic fluid is in a heat exchanger.

5. The method as claimed in claim 1 wherein a circulation is established in the removed portion of cryogenic fluid.

6. The method as claimed in claim 4 wherein a thermosiphon effect is created to circulate the removed portion of cryogenic fluid.

7. The method as claimed in claim 3 wherein the cooling is provided by a cryogenic fluid selected from the group consisting of liquefied nitrogen, liquid oxygen, liquid air, argon, and ethylene and mixtures of these fluids

8. The method as claimed in claim 1 wherein said cryogenic fluid in said storage vessel is selected from the group consisting of liquefied natural gas, liquid nitrogen, liquid oxygen, liquid air, liquid argon, and ethylene and mixtures of these fluids.

9. The method as claimed in claim 1 wherein the cooling is based on the temperature of the removed portion of the cryogenic fluid.

10. The method as claimed in claim 9 wherein the amount of cryogenic fluid supplied to the heat exchanger is adjusted to maintain the desired degree of subcooling of the cryogenic fluid.

11. The method as claimed in claim 1 further comprising circulating the removed portion of cryogenic fluid back into the storage vessel with a pump.

12. The method as claimed in claim 1 wherein said cooling is provided by mechanical refrigeration.

13. The method as claimed in claim 9 wherein said cryogenic fluid is vented from said heat exchanger.

14. A method for maintaining a predominately subcooled condition throughout a cryogenic fluid in a storage vessel comprising removing a portion of the cryogenic fluid, cooling the removed portion of cryogenic fluid and reintroducing the removed portion of cryogenic fluid back into the storage vessel.

15. The method as claimed in claim 14 wherein the removed portion of cryogenic fluid is fed back into the storage vessel at a position higher than where the cryogenic fluid was removed from the storage vessel.

16. The method as claimed in claim 14 wherein a cryogenic fluid is used to cool the removed portion of cryogenic fluid.

17. The method as claimed in claim 14 wherein a circulation is established in the cryogenic fluid.

18. The method as claimed in claim 17 where a thermosiphon effect is created in the cryogenic fluid.

19. The method as claimed in claim 14 wherein the cooling is provided by a cryogenic fluid selected from the group consisting of liquefied nitrogen, liquid oxygen, liquid air, argon, ethylene and mixtures of these fluids

20. The method as claimed in claim 14 wherein said cryogenic fluid in said storage vessel is selected from the group consisting of liquefied natural gas, liquid nitrogen, liquid oxygen, liquid air, liquid argon, and ethylene and mixtures of these fluids.

21. The method as claimed in claim 14 wherein the removal of a portion of the cryogenic fluid is continuous.

22. The method as claimed in claim 14 wherein the cryogenic fluid is in a heat exchanger.

23. The method as claimed in claim 14 wherein the amount of cryogenic fluid supplied to the heat exchanger is adjusted to maintain the desired degree of subcooling of the cryogenic fluid in said storage vessel.

24. The method as claimed in claim 14 further comprising reintroducing the removed portion of cryogenic fluid back into the storage vessel with a pump.

25. The method as claimed in claim 14 wherein said cooling is provided by mechanical refrigeration.

26. The method as claimed in claim 22 wherein said cryogenic fluid is vented from said heat exchanger.
